(19) United States
(12) Patent Application Publication
(10) Pub. No.: US 2014/0163839 A1
(43) Pub. Date: Jun. 12, 2014

(54) SYSTEMS AND METHODS FOR CONTROLLING CYLINDER DEACTIVATION AND ACCESSORY DRIVE TENSIONER ARM MOTION

(71) Applicant: GM GLOBAL TECHNOLOGY OPERATIONS LLC, Detroit, MI (US)

(72) Inventors: Eric D. Staley, Flushing, MI (US); Ronald J. Pierik, Holly, MI (US); Jeremy T. Demarest, Waterford, MI (US); Timothy M. Karnjate, Grand Blanc, MI (US)

(73) Assignee: GM Global Technology Operations LLC, Detroit, MI (US)

(21) Appl. No.: 13/712,267

(22) Filed: Dec. 12, 2012

(51) Int. Cl. F02D 17/02

(52) U.S. Cl. CPC F02D 17/02
USPC 701/103

(57) ABSTRACT

A control system for an engine includes a torque modifier module that selects one of a plurality of torque modifier values based on variations in an accessory load. A torque calculating module calculates a maximum torque value for operation in a cylinder deactivation mode based on the selected one of the plurality of torque modifier values. A torque control module selectively switches the engine between the cylinder deactivation mode and a cylinder activation mode based on the maximum torque value.

### FIELD

The present disclosure relates to internal combustion engines and more specifically to systems and methods for controlling cylinder deactivation.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which adjusts air flow into the engine. As the throttle area increases, the air flow into the engine increases. A fuel control system adjusts the rate that fuel is supplied to provide a desired air/fuel mixture to the cylinders and/or to achieve a desired torque output. Increasing the amount of air and fuel provided to the cylinders increases the torque output of the engine.

When the engine torque output capable of being produced exceeds that required for the current state of operation, one or more cylinders of an engine may be deactivated to decrease fuel consumption. Deactivation of a cylinder may include deactivating the opening and closing of intake valves of the cylinder and halting the fueling of the cylinder.

An alternator, a power steering pump, an air or vacuum pump, an air conditioning compressor, and/or other accessory may be driven by a crankshaft connected to an accessory drive belt. A tensioner arm may be used to supply or maintain tension in the accessory drive belt during engine operation. Excessive motion of the tensioner arm may occur at low engine speeds of a four cylinder engine when operating in two cylinder mode due to increased amplitudes of torque pulse irregularities produced from the reduced number of cylinder firing events. Noise, vibration and harshness (NVH), durability, and performance issues may occur as a result of the excessive motion of the tensioner arm.

### SUMMARY

A control system for an engine includes a torque modifier module that selects one of a plurality of torque modifier values based on variations in an accessory load. A torque calculating module calculates a maximum torque value for operation in a cylinder deactivation mode based on the selected one of the plurality of torque modifier values. A torque control module selectively switches the engine between the cylinder deactivation mode and a cylinder activation mode based on the maximum torque value.

In other features, the engine is a four cylinder engine and the engine operates using two cylinders when in the cylinder deactivation mode. The accessory load includes an alternator. The accessory load includes an air conditioning (AC) compressor. The accessory load includes an alternator and an air conditioning (AC) compressor.

In other features, the torque modifier module selects a first torque modifier when an electrical demand is greater than a first level and the AC compressor is on; a second torque modifier when an electrical demand is greater than a first level and the AC compressor is off; a third torque modifier when an electrical demand is less than a first level and the AC compressor is on; and a fourth torque modifier when an electrical demand is less than a first level and the AC compressor is off. The first torque modifier, the second torque modifier, the third torque modifier and the fourth torque modifier are different values.

In other features, the torque calculating module comprises a minimum vacuum calculating module that calculates a minimum vacuum value for operation in the cylinder deactivation mode based on the selected one of the plurality of torque modifier values. A maximum torque calculating module calculates the maximum torque value for operation in the cylinder deactivation mode based on the minimum vacuum value.

A method for controlling an engine includes selecting one of a plurality of torque modifier values based on variations in an accessory load; calculating a maximum torque value for operation of the engine in a cylinder deactivation mode based on the selected one of the plurality of torque modifier values; and selectively switching the engine between the cylinder deactivation mode and a cylinder activation mode based on the maximum torque value.

In other features, the engine is a four cylinder engine and the engine operates using two cylinders when in the cylinder deactivation mode. The accessory load includes an alternator. The accessory load includes an air conditioning (AC) compressor. The accessory load includes an alternator and an air conditioning (AC) compressor.

In other features, the method includes selecting a first torque modifier when an electrical demand is greater than a first level and the AC compressor is on; a second torque modifier when an electrical demand is greater than a first level and the AC compressor is off; a third torque modifier when an electrical demand is less than a first level and the AC compressor is on; and a fourth torque modifier when an electrical demand is less than a first level and the AC compressor is off. In other features, the first torque modifier, the second torque modifier, the third torque modifier and the fourth torque modifier are different values.

In other features, the method includes calculating a minimum vacuum value for operation in the cylinder deactivation mode based on the selected one of the plurality of torque modifier values; calculating the maximum torque value for operation in the cylinder deactivation mode based on the minimum vacuum value; and transitioning the engine between the cylinder deactivation mode and a cylinder activated mode based on the maximum torque value.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a graph showing an example of tensioner arm movement as a function of engine speed;

FIG. 2 is a functional block diagram of an example of an engine system according to the present disclosure;

FIG. 3 illustrates an engine including a continuous drive belt and a tensioner arm;

FIG. 4 is a functional block diagram of an example of an engine control module according to the present disclosure;

FIG. 5 is a functional block diagram of another example of an engine control module according to the present disclosure; and

FIG. 6 is an example of a flowchart for controlling cylinder deactivation to reduce motion of the tensioner arm according to the present disclosure.

### DETAILED DESCRIPTION

When an engine operates with fewer cylinders than the full number of cylinders in a cylinder deactivation mode, the rigid body motion of the crankshaft increases due to the increased torque fluctuations from lower order firing events such as first order events. The first order firing events occur during two-cylinder mode operation. If the engine is operating in four-cylinder mode, the firing events are second order—two firing events per crankshaft revolution.

The first-order firing torque fluctuations (engine operating in two-cylinder mode) may be transmitted from a crankshaft pulley to an accessory drive belt. The rigid body motion is due to the change in angular acceleration of the crankshaft and therefore angular speed variation around the mean crankshaft speed. As the number of firing events per cycle reduces, this speed variation increases, increasing the rigid body motion. Crankshaft stiffness is also considered when dealing with rigid body motion, but for two-cylinder operation, angular speed variation in each crankshaft cycle dominates. As a result, the system experiences reversals in torque. The increased motion of the tensioner arm can lead to premature failure of a damping shoe of the tensioner and may eventually seize or prematurely wear out the tensioner arm.

According to the present invention, the torque output of the engine is limited in a cylinder deactivation mode at low engine speeds so that motion of the tensioner arm can be limited to levels that are within durability limits of the tensioner arm.

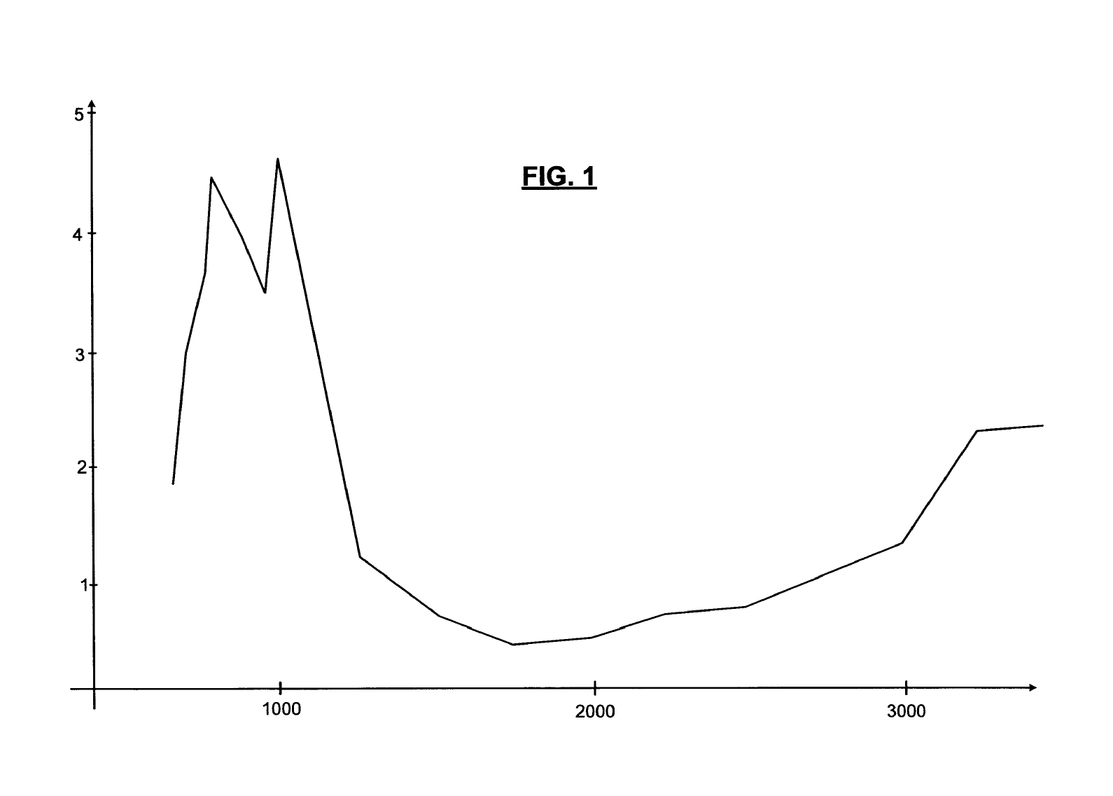

Referring now to FIG. 1, an example of tensioner arm movement as a function of engine speed is shown. The tensioner arm movement is greater at low engine speeds.

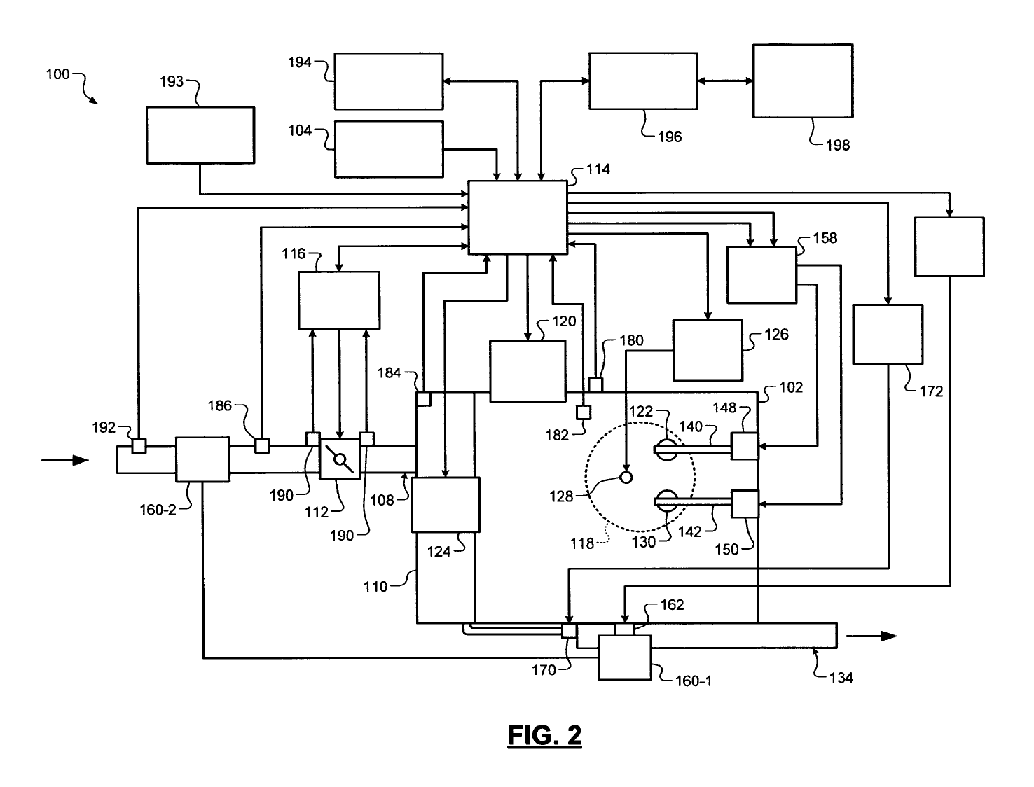

Referring now to FIG. 2, a functional block diagram of an example engine system 100 is presented. The engine system 100 of a vehicle includes an engine 102 that combusts an air/fuel mixture to produce torque based on driver input from a driver input module 104. Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, as discussed further below, which may improve fuel efficiency.

The engine 102 may operate using a four-stroke cycle. The four strokes, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may halt provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time at which the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The cylinder actuator module 120 may deactivate the cylinder 118 by deactivating opening of the intake valve 122 and/or the exhaust valve 130. The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158. In various other implementations, the intake valve 122 and/or the exhaust valve 130 may be controlled by actuators other than camshafts, such as electromechanical actuators, electrohydraulic actuators, electromagnetic actuators, etc.

The engine system 100 may include a boost device that provides pressurized air to the intake manifold 110. For example, FIG. 1 shows a turbocharger including a turbine 160-1 that is driven by exhaust gases flowing through the exhaust system 134. The turbocharger also includes a compressor 160-2 that is driven by the turbine 160-1 and that compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. Although shown separated for purposes of illustration, the turbine 160-1 and the compressor 160-2 may be mechanically linked to each other, placing intake air in close proximity to hot exhaust. The compressed air charge may absorb heat from components of the exhaust system 134.

The engine system 100 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172.

Crankshaft position may be measured using a crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192. The engine system 100 may also include one or more other sensors 193. The ECM 114 may use signals from the sensors to make control decisions for the engine system 100.

The ECM 114 may communicate with a transmission control module 194 to coordinate shifting gears in a transmission (not shown). For example, the ECM 114 may reduce engine torque during a gear shift. The engine 102 outputs torque to a transmission (not shown) via the crankshaft. One or more coupling devices, such as a torque converter and/or one or more clutches, regulate torque transfer between a transmission input shaft and the crankshaft. Torque is transferred between the transmission input shaft and a transmission output shaft via the gears.

Torque is transferred between the transmission output shaft and wheels of the vehicle via one or more differentials, driveshafts, etc. Wheels that receive torque output by the transmission will be referred to as drive wheels. Wheels that do not receive torque from the transmission will be referred to as undriven wheels.

The ECM 114 may communicate with a hybrid control module 196 to coordinate operation of the engine 102 and one or more electric motors 198. The electric motor 198 may also function as a generator, and may be used to produce electrical energy for use by vehicle electrical systems and/or for storage in a battery. In various implementations, various functions of the ECM 114, the transmission control module 194, and the hybrid control module 196 may be integrated into one or more modules.

Each system that varies an engine parameter may be referred to as an engine actuator. Each engine actuator receives an actuator value. For example, the throttle actuator module 116 may be referred to as an engine actuator, and the throttle opening area may be referred to as the actuator value. In the example of FIG. 2, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the boost actuator module 164, and the EGR actuator module 172. For these engine actuators, the actuator values may correspond to a cylinder activation/deactivation sequence, fueling rate, intake and exhaust cam phaser angles, boost pressure, and EGR valve opening area, respectively. The ECM 114 may generate the actuator values in order to cause the engine 102 to generate a desired engine output torque.

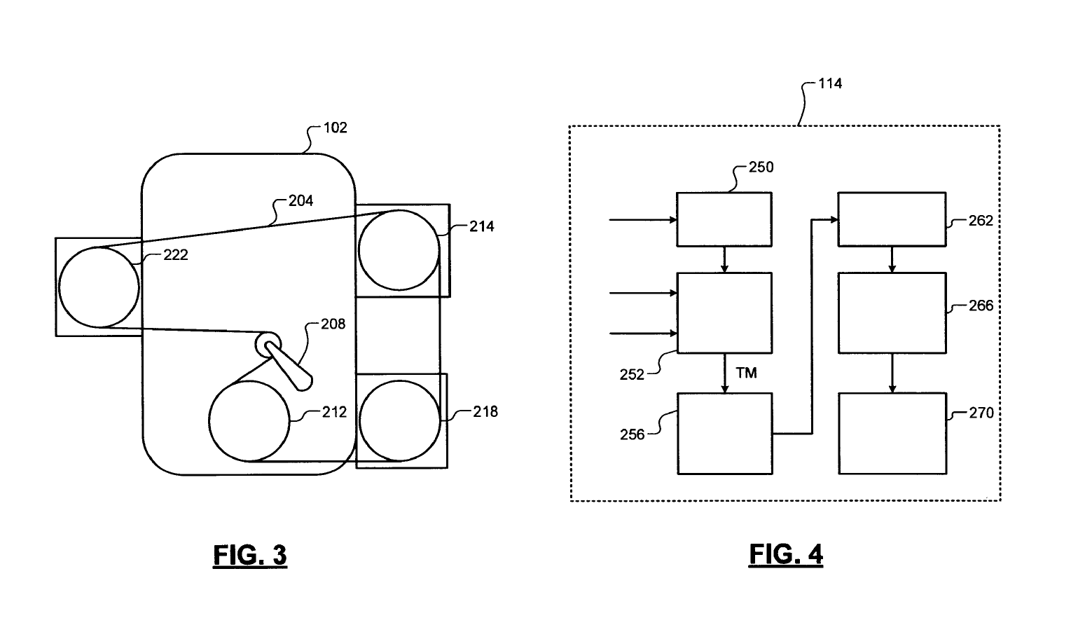

Referring now to FIG. 3, the engine 102 includes an accessory belt 204 and a tensioner arm 208. The accessory belt 204 may be driven by a crankshaft pulley 212. The accessory belt 204 may be used to drive one or more accessories. For example, the accessory belt 204 may be used to drive an A/C pulley 218, an alternator pulley 222 and/or one or more other accessories such as an air pump, a vacuum pump, and a power steering pump.

Referring now to FIG. 4, an example of an engine control module 114 according to the present disclosure is shown. The engine control module 114 includes an enabling module 250. The enabling module 250 receives an engine RPM signal and selectively enables a torque modifier module 252 based on the engine RPM signal. For example only, the enabling module 250 may enable the torque modifier module 252 when the engine RPM is less than a predetermined engine RPM. The torque modifier module 252 selectively generates a torque modifier value based on a load of accessories connected to the accessory belt 204. For example, the torque modifier module 252 may select the torque modifier value based on whether the A/C is on or off, a level of electrical demand (to determine a load on the alternator or generator), and/or other loads on the accessory belt 204. In one example, the torque modifier module 252 may compare the electrical demand to a predetermined electrical demand such as 50%.

The torque modifier module 252 outputs the torque modifier value to a maximum torque calculating module 256. The torque calculating module 256 calculates a maximum torque that the engine can be operated in before requiring a transition from the cylinder deactivation mode to the cylinder activated mode. The maximum torque calculating module 256 outputs the maximum torque value to a torque control module 262, which determines the torque output of the engine. An output of the torque control module 262 is output to a desired air per cylinder (APC) and manifold absolute pressure (MAP) calculating module 266, which calculates desired APC and MAP. An output of the desired APC and MAP calculating module 266 is input to a throttle area calculating module 270, which calculates a throttle area based on the desired APC and MAP.

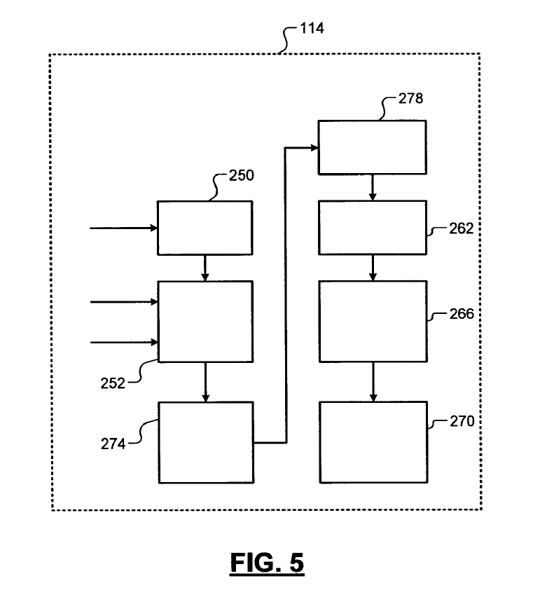

Referring now to FIG. 5, a minimum vacuum calculating module 274 may calculate a minimum vacuum value based on the torque modifier value and output the minimum vacuum value to the maximum torque calculating module 278. The maximum torque calculating module 278 calculates the maximum torque based on the minimum vacuum value.

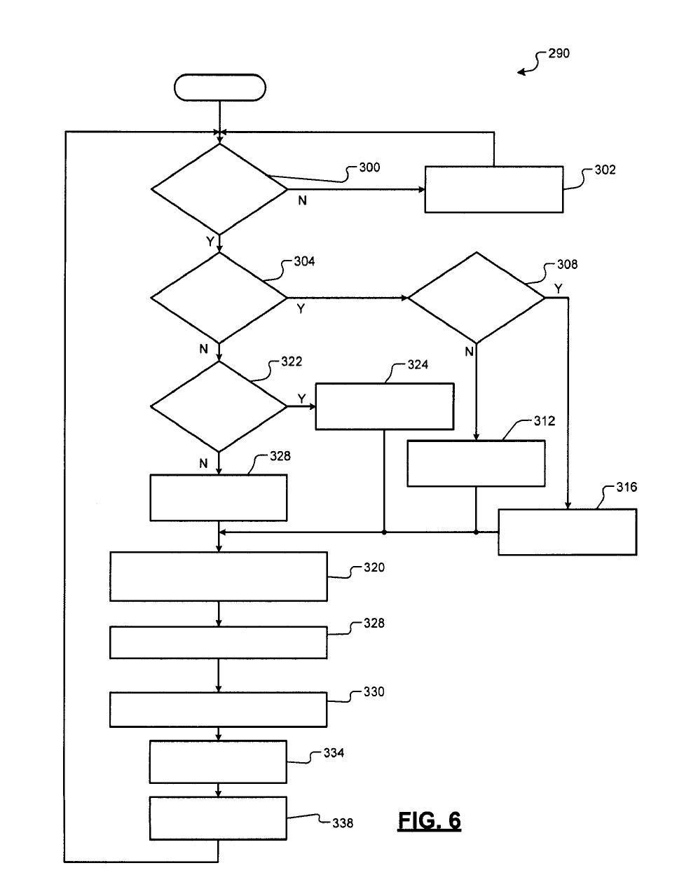

Referring now to FIG. 6, an example of a method 290 for controlling cylinder deactivation to reduce motion of the tensioner arm according to the present disclosure is shown. At 300, control compares engine RPM to a predetermined engine RPM. If the engine RPM is greater than the predetermined engine RPM, no torque limit is used to attempt to limit tensioner arm motion. If 300 is true, control continues at 304 and determines whether the electrical demand is greater than or equal to a predetermined value, such as but not limited to, 50%. If 304 is true, control continues at 308 and determines whether the A/C is on. If 308 is false, control sets the torque modifier to a first torque modifier value at 312 and control continues at 320. If 308 is true, control sets the torque modifier to a second torque modifier value at 316 and control continues at 320. If 304 is false, control continues at 322 and determines whether the A/C is on. If 322 is true, control sets the torque modifier to a third torque modifier value at 324 and control continues at 320. If 322 is false, control sets the torque modifier value to a fourth value at 328.

At 320, control calculates a minimum vacuum value for transition based on the selected torque modifier. At 328, control calculates a maximum torque value for operation in the cylinder deactivation mode before a transition occurs to the cylinder activated mode. At 330, control performs torque control based on the maximum torque value. At 334, control calculates desired APC and MAP values. At 338, control calculates a desired throttle area based on the desired APC and MAP values.

As can be appreciated, limiting tensioner arm movement at low engine rpm leads to increased durability of the tensioner arm while operating the engine in the cylinder deactivation mode. In addition, the engine will have increased fuel efficiency as compared to engines that limit cylinder deactivation purely based on engine speed by not limiting the minimum engine speed for operating in the cylinder deactivation mode due to tensioner durability concerns.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A control system for an engine, comprising:
a torque modifier module that selects one of a plurality of torque modifier values based on variations in an accessory load;
a torque calculating module that calculates a maximum torque value for operation in a cylinder deactivation mode based on the selected one of the plurality of torque modifier values; and
a torque control module that selectively switches the engine between the cylinder deactivation mode and a cylinder activation mode based on the maximum torque value.

2. The control system of claim 1, wherein the engine is a four cylinder engine and wherein the engine operates using two cylinders when in the cylinder deactivation mode.

3. The control system of claim 1, wherein the accessory load includes an alternator.

4. The control system of claim 1, wherein the accessory load includes an air conditioning (AC) compressor.

5. The control system of claim 1, wherein the accessory load includes at least two of an alternator, an air pump, a vacuum pump, a power steering pump, and an air conditioning (AC) compressor.

6. The control system of claim 5, wherein the torque modifier module selects:
a first torque modifier when an electrical demand is greater than a first level and the AC compressor is on;
a second torque modifier when an electrical demand is greater than a first level and the AC compressor is off;
a third torque modifier when an electrical demand is less than a first level and the AC compressor is on; and
a fourth torque modifier when an electrical demand is less than a first level and the AC compressor is off.

7. The control system of claim 6, wherein the first torque modifier, the second torque modifier, the third torque modifier and the fourth torque modifier are different values.

8. The control system of claim 1, wherein the torque calculating module comprises:
a minimum vacuum calculating module that calculates a minimum vacuum value for operation in the cylinder deactivation mode based on the selected one of the plurality of torque modifier values; and
a maximum torque calculating module that calculates the maximum torque value for operation in the cylinder deactivation mode based on the minimum vacuum value.

9. A method for controlling an engine, comprising:
selecting one of a plurality of torque modifier values based on variations in an accessory load;
calculating a maximum torque value for operation of the engine in a cylinder deactivation mode based on the selected one of the plurality of torque modifier values; and
selectively switching the engine between the cylinder deactivation mode and a cylinder activation mode based on the maximum torque value.

10. The method of claim 9, wherein the engine is a four cylinder engine and wherein the engine operates using two cylinders when in the cylinder deactivation mode.

11. The method of claim 9, wherein the accessory load includes an alternator.

12. The method of claim 9, wherein the accessory load includes an air conditioning (AC) compressor.

13. The method of claim 9, wherein the accessory load includes at least two of an alternator, an air pump, a vacuum pump, a power steering pump, and an air conditioning (AC) compressor.

14. The method of claim 13, further comprising selecting:
a first torque modifier when an electrical demand is greater than a first level and the AC compressor is on;
a second torque modifier when an electrical demand is greater than a first level and the AC compressor is off;
a third torque modifier when an electrical demand is less than a first level and the AC compressor is on; and
a fourth torque modifier when an electrical demand is less than a first level and the AC compressor is off.

15. The method of claim 14, wherein the first torque modifier, the second torque modifier, the third torque modifier and the fourth torque modifier are different values.

16. The method of claim 9, further comprising:
calculating a minimum vacuum value for operation in the cylinder deactivation mode based on the selected one of the plurality of torque modifier values;
calculating the maximum torque value for operation in the cylinder deactivation mode based on the minimum vacuum value; and
transitioning the engine between the cylinder deactivation mode and a cylinder activated mode based on the maximum torque value.
